(19) United States
(12) Patent Application Publication
(10) Pub. No.: US 2014/0290369 A1
(43) Pub. Date: Oct. 2, 2014

(54) ULTRASONIC MEASURING SYSTEM, ULTRASONIC PROBE, AND SHEET MEMBER

(71) Applicant: SEIKO EPSON CORPORATION, Tokyo (JP)

(72) Inventor: Kanechika KIYOSE, Matsumoto (JP)

(73) Assignee: SEIKO EPSON CORPORATION, Tokyo (JP)

(21) Appl. No.: 14/227,457

(22) Filed: Mar. 27, 2014

(30) Foreign Application Priority Data
Mar. 29, 2013 (JP) 2013-071598

(51) Int. Cl. G01N 29/24

(52) U.S. Cl. CPC G01N 29/24
USPC 73/632

(57) ABSTRACT

An ultrasonic measuring system includes an ultrasonic probe and a sheet member. The ultrasonic probe has an ultrasonic sensor section and a probe side engaging section. Ultrasonic waves emitted from the ultrasonic sensor section are transmitted through the sheet member to a target sample. The sheet member has a sheet side engaging section. The probe side engaging section slidably engages with the sheet side engaging section so that the ultrasonic probe slides along the sheet member while the ultrasonic sensor section faces a sheet surface of the sheet member.

### CROSS-REFERENCE TO RELATED APPLICATIONS

This application claims priority to Japanese Patent Application No. 2013-071598 filed on Mar. 29, 2013. The entire disclosure of Japanese Patent Application No. 2013-071598 is hereby incorporated herein by reference.

### BACKGROUND

1. Technical Field

The present invention relates to an ultrasonic measuring system, an ultrasonic probe, a sheet, and the like.

2. Related Art

Methods of obtaining panoramic images by using an ultrasonic measuring system (an ultrasonic diagnostic apparatus) are known. In order to obtain a panoramic image, it is necessary for a technician to perform ultrasonic measurement while moving an ultrasonic probe along a desired track freehand. However, it is difficult to accurately move the probe along the intended track and maintain a constant pressing force with regard to a body surface while holding the probe to be orthogonal with regard to the body surface at all times and, as a result, there is a problem in that it is difficult to obtain an accurate panoramic image.

With regard to this problem, for example, Japanese Unexamined Patent Application Publication No. 2007-21172 discloses a method of guiding movement of an ultrasonic probe using guide rails. However, in this method, there are problems such as that it is difficult to carry out accurate measurement to match with the various shapes, body types, and the like of parts to be measured, and that the apparatus becomes complicated.

### SUMMARY

According to several aspects of the present invention, it is possible to provide an ultrasonic measuring system, an ultrasonic probe, a sheet, and the like where it is possible to acquire ultrasonic images while moving an ultrasonic probe along a desired track.

One aspect of the present invention relates to an ultrasonic measuring system which includes an ultrasonic probe and a sheet member. The ultrasonic probe has an ultrasonic sensor section and a probe side engaging section. Ultrasonic waves emitted from the ultrasonic sensor section are transmitted through the sheet member to a target sample. The sheet member has a sheet side engaging section. The probe side engaging section slidably engages with the sheet side engaging section so that the ultrasonic probe slides along the sheet member while the ultrasonic sensor section faces a sheet surface of the sheet member.

According to the one aspect of the present invention, it is possible to restrict movement of the ultrasonic probe since it is possible for the probe side engaging section to engage with the sheet side engaging section. As a result, it is possible to move the ultrasonic probe along a track which is defined by the sheet member.

In addition, in the one aspect of the present invention, the sheet side engaging section is preferably defined by a pair of end portions of the sheet member in a width direction of the sheet member.

According to this, it is possible to restrict movement of the ultrasonic probe since it is possible for the probe side engaging section to engage with the end portions of the sheet member. As a result, it is possible to move the ultrasonic probe along a track which is defined by the sheet member.

In addition, in the one aspect of the present invention, the sheet side engaging section is preferably defined by a groove section arranged on the sheet surface.

According to this, it is possible to restrict movement of the ultrasonic probe since it is possible for the probe side engaging section to engage with the groove section of the sheet. As a result, it is possible to move the ultrasonic probe along a track which is defined by the sheet member.

In addition, in the one aspect of the present invention, the probe side engaging section preferably includes a first engaging portion and a second engaging portion, the groove section preferably includes a first groove portion and a second groove portion, the first engaging portion preferably engages with the first groove portion, and the second engaging portion preferably engages with the second groove portion.

According to this, it is possible to restrict movement of the ultrasonic probe since it is possible for the first and second engaging portions of the ultrasonic probe to engage with the first and second groove portions of the sheet member. As a result, it is possible to move the ultrasonic probe along a track which is defined by the sheet member.

In addition, in the one aspect of the present invention, the ultrasonic sensor section is preferably disposed between the first engaging portion and the second engaging portion.

According to this, it is possible to restrict movement of the ultrasonic sensor section by the first and second engaging portions of the ultrasonic probe engaging with the first and second groove portions of the sheet member.

In addition, in the one aspect of the present invention, the ultrasonic probe preferably includes a sensor surface on which the ultrasonic sensor section is arranged, the sensor surface having a rectangular shape in a plan view, and the probe side engaging section preferably includes a first engaging portion, a second engaging portion, a third engaging portion, and a fourth engaging portion disposed at four corner sections of the sensor surface in the plan view.

According to this, it is possible to restrict movement of the ultrasonic probe by the first to fourth engaging portions of the ultrasonic probe engaging with the sheet side engaging section.

In addition, in the one aspect of the present invention, the probe side engaging section preferably includes a guide section configured and arranged to guide movement of the ultrasonic probe in a longitudinal direction of the sheet member.

According to this, it is possible to guide movement of the ultrasonic probe in the longitudinal direction of the sheet member by the probe side engaging section engaging with the sheet side engaging section.

In addition, in the one aspect of the present invention, the ultrasonic probe preferably has a sensor surface on which the ultrasonic sensor section is arranged with a probe side groove section being provided on the sensor surface, and the probe side groove section preferably extends along a longitudinal direction of the sheet member when the sheet side engaging section and the probe side engaging section are engaged.

According to this, it is possible to prevent air from entering between the ultrasonic sensor section and the sheet member since it is possible to efficiently collect a gel, which is coated on the sheet, on the emission surface of the ultrasonic sensor section through the probe side groove section.

In addition, in the one aspect of the present invention, the ultrasonic probe preferably has a sensor surface on which the ultrasonic sensor section is arranged, and a height of the probe side engaging section from the sensor surface is preferably equal to or less than a thickness of the sheet member.

According to this, it is possible to reliably perform ultrasonic measurement since it is possible for the sensor surface of the ultrasonic probe to come into contact with the surface of the sheet member.

In addition, in the one aspect of the present invention, the ultrasonic measuring system preferably further includes a transmitting section configured to perform a process of transmitting ultrasonic waves, a receiving section configured to perform a process of receiving ultrasonic echoes, and a processing section configured to perform a process of controlling ultrasonic measurement. The processing section is preferably configured to generate an ultrasonic panoramic image in a longitudinal direction of the sheet member based on a reception signal from the receiving section.

According to this, it is possible to easily obtain an ultrasonic panoramic image since it is possible for a user to carry out measurement while accurately moving the ultrasonic probe in the longitudinal direction of the sheet member.

In addition, in the one aspect of the present invention, the ultrasonic measuring system preferably further includes a display section configured to display image data.

According to this, it is possible for the display section to display image data which is acquired according to ultrasonic measurement.

Another aspect of the present invention relates to an ultrasonic probe adapted to slidably engage with a sheet member arranged between the ultrasonic probe and a target sample. The ultrasonic probe includes an ultrasonic sensor section disposed on a sensor surface of the ultrasonic probe, and an engaging section disposed on the sensor surface, and configured and arranged to engage with the sheet member to guide the ultrasonic probe to slide along the sheet member while the ultrasonic sensor section faces a sheet surface of the sheet member.

Another aspect of the present invention relates to a sheet member adapted to be arranged between an ultrasonic probe and a target sample. The sheet member includes an ultrasonic transmissive medium, and an engaging section configured and arranged to engage with the ultrasonic probe to guide the ultrasonic probe to slide along a sheet surface of the sheet member.

According to another aspect of the present invention, it is possible for the ultrasonic probe to move by sliding along a track which is defined by the sheet member.

In addition, in another aspect of the present invention, the engaging section is preferably configured and arranged to guide the ultrasonic probe to move by sliding in the longitudinal direction of the sheet member.

According to this, it is possible to guide the ultrasonic probe to move by sliding in the longitudinal direction of the sheet member by the engaging section engaging with the probe side engaging section.

In addition, in another aspect of the present invention, the engaging section preferably includes a groove section arranged on the sheet surface.

According to this, it is possible to guide the ultrasonic probe to move by sliding by the groove section engaging with the probe side engaging section.

In addition, in another aspect of the present invention, the ultrasonic transmissive medium preferably includes a base sheet made of a base material and a first gel layer disposed on a surface of the base sheet opposite from the sheet surface on which the groove section is arranged.

According to this, it is possible to prevent air from entering between the target sample and the sheet member by the sheet member adhering to the target sample during ultrasonic measurement.

In addition, in another aspect of the present invention, the ultrasonic transmissive medium preferably further includes a second gel layer disposed on a surface of the base sheet on a same side as the sheet surface on which the groove section is arranged.

According to this, it is possible to prevent air from entering between the ultrasonic probe and the sheet by the sheet member adhering to the ultrasonic probe during ultrasonic measurement.

### BRIEF DESCRIPTION OF THE DRAWINGS

Referring now to the attached drawings which form a part of this original disclosure:

FIG. 1 is a basic configuration example of an ultrasonic probe.

FIG. 2 is a comparative example of an ultrasonic probe.

FIG. 3A and FIG. 3B are a first configuration example of an ultrasonic probe.

FIG. 4A and FIG. 4B are modified examples of the first configuration example of an ultrasonic probe.

FIG. 5A and FIG. 5B are a second configuration example of an ultrasonic probe.

FIG. 6A and FIG. 6B are a first example of ultrasonic measurement.

FIG. 7A and FIG. 7B are a second example of ultrasonic measurement.

FIG. 8A and FIG. 8B are a configuration example of a sheet and FIG. 8C is a modified example of a sheet.

FIG. 9A is a diagram which describes movement of an ultrasonic probe which is guided and FIG. 9B is a diagram illustrating generation of a 3D ultrasonic image.

FIG. 10A and FIG. 10B are a basic configuration example of an ultrasonic transducer element.

FIG. 11 is a configuration example of an ultrasonic transducer device.

FIG. 12 is a basic configuration example of an ultrasonic measuring system.

FIG. 13A and FIG. 13B are basic configuration examples of ultrasonic measuring systems.

### DETAILED DESCRIPTION OF EXEMPLARY EMBODIMENTS

Below, preferable embodiments of the present invention will be described in detail. Here, the present embodiment described below is not limited by the content of the present invention described in the scope of the claims and the entire configuration described in the present embodiment is not necessarily essential as a means to solve the problems in the present invention.

### 1. Ultrasonic Probe

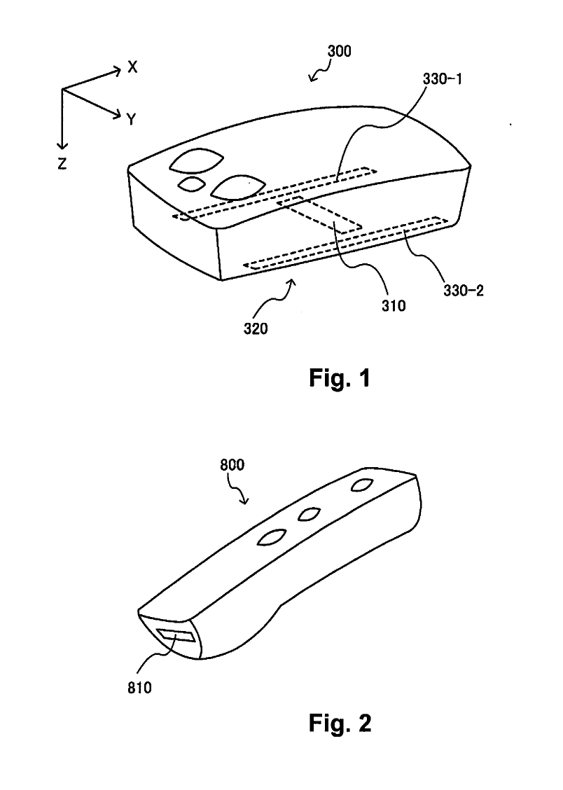

FIG. 1 illustrates a basic configuration example of an ultrasonic probe 300 of the present embodiment. The ultrasonic probe 300 of the present embodiment includes an ultrasonic sensor section 310 and probe side engaging sections 330 (330-1 and 330-2). Here, the ultrasonic probe 300 of the present embodiment is not limited to the configuration of FIG. 1 and various modified examples are possible such as omitting a portion of constituent components of the ultrasonic probe 300, replacing other constituent components, adding constituent components, or the like.

As shown in FIG. 1, the surface of the ultrasonic probe 300 which faces a target sample side during measurement is a sensor surface 320, the longitudinal direction of the sensor surface 320 is an X direction, a direction which intersects with the X direction is a Y direction, and a direction which faces the target sample during measurement and which intersects with the X direction and the Y direction is a Z direction.

The sensor surface 320 is one surface out of the surfaces which form the outer surfaces of the casing of the ultrasonic probe 300 and is a surface which faces the target sample side during ultrasonic measurement. The sensor surface 320 may be a flat surface or may be a curved surface. The sensor surface 320 has, for example, an elongated shape or a rectangular shape in a plan view when viewed from the Z direction side. The longitudinal direction of the sensor surface 320 is, for example, the direction along the length direction in a case where the sensor surface 320 is an elongated shape in a plan view and the direction along the long side in a case where the sensor surface 320 is a rectangular shape in a plan view. The sensor surface 320 may be, for example, an elliptical shape in a plan view or a shape which is close to elliptical in a plan view, or may be a shape with the four corners of a rectangle cut away in a plan view or a shape which is close to this shape.

The ultrasonic sensor section 310 has an ultrasonic transducer device (which is not shown in the diagram), and transmits ultrasonic waves with regard to a target sample (a target object) and receives ultrasonic echoes from the target sample. The ultrasonic sensor section 310 is provided with the sensor surface 320 such that the scanning direction or the slice direction of the ultrasonic transducer device is along the direction (the Y direction) which intersects with the longitudinal direction of the sensor surface 320. For example, as shown in FIG. 1, the ultrasonic sensor section 310 is arranged between a first engaging portion 330-1 and a second engaging portion 330-2. The details of the ultrasonic transducer device will be described later.

The probe side engaging sections 330 engage with sheet side engaging sections of a sheet such that the ultrasonic sensor section 310 is able to move by sliding at a position which faces the sheet surface of the sheet. The sheet is a sheet which is arranged for use between the ultrasonic probe 300 and the target sample and it is possible to transmit ultrasonic waves which are emitted from the ultrasonic sensor section 310 to the target sample.

The probe side engaging sections 330 are, for example, members which are provided on the sensor surface 320 and which protrude from the sensor surface 320 to the target sample side (the Z direction side). The probe side engaging sections 330 are the first engaging portion 330-1 and the second engaging portion 330-2 which are provided such that, for example, the longitudinal direction is the X direction as shown in FIG. 1.

As described later, when performing ultrasonic measurement, it is possible for the probe side engaging sections 330 to guide the ultrasonic probe 300 to move by sliding at positions where the ultrasonic sensor section 310 faces the sheet surface of the sheet by engaging with the sheet side engaging section which is fixed to the target sample. That is, the probe side engaging sections 330 are guiding sections which guide the ultrasonic probe 300 to move by sliding in the longitudinal direction of the sheet.

In detail, the probe side engaging sections 330 come into contact with and fit together with the sheet side engaging sections, and movement of the ultrasonic probe 300 in the Y direction is restricted due to the probe side engaging sections 330 fitting together with the sheet side engaging sections. As a result of restricting movement in the Y direction, movement is defined along the longitudinal direction (the X direction) of the sheet when a user moves the ultrasonic probe 300.

FIG. 2 illustrates an ultrasonic probe 800 as a comparative example. The ultrasonic probe 800 of the comparative example shown in FIG. 2 is provided with an ultrasonic sensor section 810 at a front edge portion of the ultrasonic probe 800 in the longitudinal direction which is different to the ultrasonic probe 300 of the present embodiment. With the ultrasonic probe 800, it is difficult to perform measurement while stably holding the probe to be orthogonal to the target sample surface.

On the other hand, it is possible to provide the ultrasonic sensor section at a position at the center of gravity of the probe or a position which is close to the position at the center of gravity since the ultrasonic probe 300 of the present embodiment has the shape of a computer mouse as shown in FIG. 1. By doing this, it is easy to perform measurement while stably holding the probe to be orthogonal to the target sample surface.

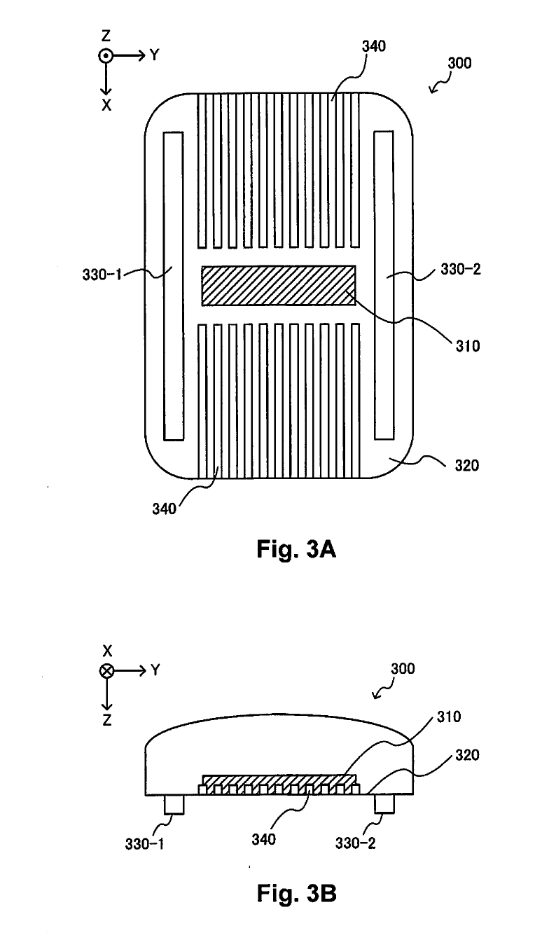

FIG. 3A and FIG. 3B illustrate a first configuration example of the ultrasonic probe 300 of the present embodiment. The ultrasonic probe 300 of the first configuration example includes the ultrasonic sensor section 310, the first and second engaging portions 330-1 and 330-2, and probe side groove sections 340. Here, the ultrasonic probe 300 of the present embodiment is not limited to the configuration of FIG. 3A and FIG. 3B and various modified examples are possible such as omitting a portion of constituent components of the ultrasonic probe 300, replacing other constituent components, adding constituent components, or the like. It is possible to, for example, omit the probe side groove sections 340.

FIG. 3A is a diagram which is viewed from the Z direction side, that is, the side of the sensor surface 320 which is the surface which faces the target sample side during measurement and FIG. 3B is a schematic diagram which is viewed from the −X direction side. Here, each of the X, Y, and Z directions correspond to the directions shown in FIG. 1.

The sensor surface 320 of the ultrasonic probe 300 shown in FIG. 3A has a shape which is close to a rectangular shape in a plan view which is viewed from the Z direction side. In detail, the sensor surface 320 has a shape which is changed such that the four corners of the rectangle are rounded.

Since the ultrasonic sensor section 310 was already described in FIG. 1, detailed description will be omitted here. Here, the ultrasonic emission surface of the ultrasonic sensor section 310 need not be provided in the same plane as the sensor surface 320, and a portion (for example, an acoustic lens, or the like) of the ultrasonic sensor section 310 may be pushed out from the sensor surface 320 in the Z direction. Alternatively, the ultrasonic emission surface of the ultrasonic sensor section 310 may conversely be retracted from the sensor surface 320 in the −Z direction.

The first and second engaging portions 330-1 and 330-2 are provided on the sensor surface 320 such that the longitudinal direction is the X direction and guide the movement of the ultrasonic probe 300 in the longitudinal direction of the sheet. The first engaging portion 330-1 is provided on the −Y direction side with regard to a central axis which passes through the center of the sensor surface 320 and which is parallel with the X direction, and the second engaging portion 330-2 is provided on the +Y direction side with regard to a central axis which passes through the center of the sensor surface 320 and which is parallel with the X direction.

For example, shown in FIG. 3A and FIG. 3B, the first and second engaging portions 330-1 and 330-2 are members which have a length in the X direction and a width in the Y direction and which protrude in the Z direction (the target sample side) and the cross section along the Y direction has a shape which is rectangular or close to rectangular. Here, the first and second engaging portions 330-1 and 330-2 need not have the same shape and, for example, the length of the first engaging portion 330-1 may be longer than the length of the second engaging portion 330-2 and the width of the first engaging portion 330-1 may be wider than the width of the second engaging portion 330-2. Alternatively, the cross section shapes of the first engaging portion 330-1 and the second engaging portion 330-2 may be different. The thickness of the first engaging portion 330-1 in the Z direction may be, for example, thicker than the thickness of the second engaging portion 330-2 in the Z direction.

The probe side groove sections 340 are groove sections which have a length in the X direction, a width in the Y direction, and a depth in the −Z direction and which are openings in the sensor surface 320 and are provided on the sensor surface 320 such that the longitudinal direction is the X direction. That is, the probe side groove sections 340 are provided in the longitudinal direction of a sheet 200 (example of a sheet member) when the sheet side engaging sections and the probe side engaging sections 330 are engaged. The probe side groove sections 340 have a concave shape in the cross section along the Y direction. A plurality of the probe side groove sections 340 may be provided in the sensor surface 320 at, for example, each of a region on the +X direction side and a region on the −X direction side with regard to the ultrasonic sensor section 310 as shown in FIG. 3A and FIG. 3B. The number of the probe side groove sections 340 is not limited to the number shown in the diagram. Each of the groove sections of the plurality of probe side groove sections 340 need not have the same shape and, for example, the length, the width, the depth, and the like of each of the groove sections may be different to each other. In addition, each of the groove sections need not be parallel with each other.

By providing the probe side groove sections 340, it is possible to efficiently gather gel, which is coated on the target sample surface or the sheet, on the emission surface of the ultrasonic sensor section 310 via the probe side groove sections 340 in a case where ultrasonic measurement is performed while moving the ultrasonic probe 300 in the X direction. By doing this, it is possible to prevent air from entering between the ultrasonic sensor section 310 and the sheet.

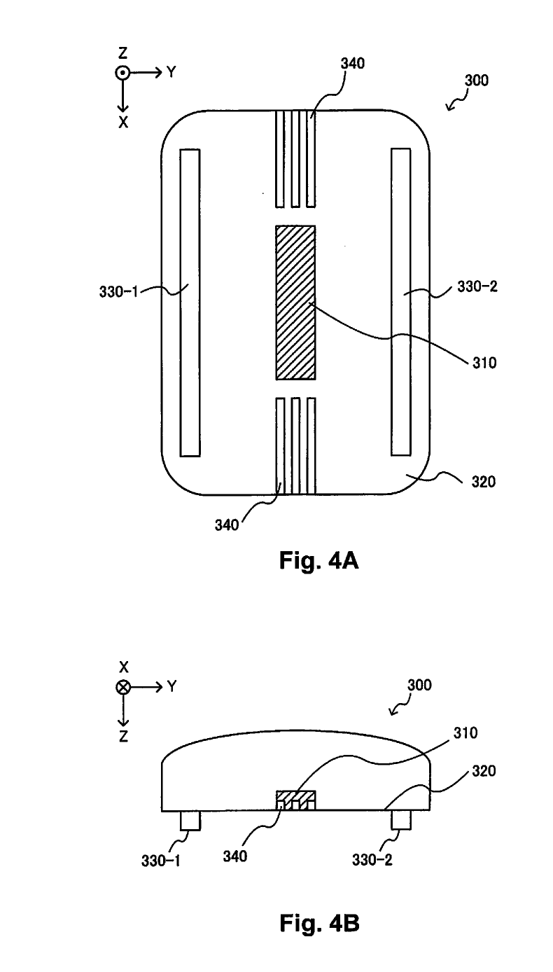

FIG. 4A and FIG. 4B illustrate a modified example of the first configuration example of the ultrasonic probe 300 of the present embodiment. In the modified example of the first configuration example, the ultrasonic sensor section 310 is provided with a sensor surface 320 such that the scanning direction of the ultrasonic transducer device is parallel with the longitudinal direction of the sensor surface 320. The first and second engaging portions 330-1 and 330-2 guide movement of the sensor surface 320 of the ultrasonic probe 300 in the longitudinal direction. That is, it is possible to guide movement of the ultrasonic probe 300 in the scanning direction.

According to the modified example of the first configuration example of the ultrasonic probe 300 of the present embodiment, it is possible to easily acquire a plurality of ultrasonic images along the desired track by performing ultrasonic measurement while moving the ultrasonic probe 300 in the scanning direction along a desired track. As a result, for example, it is possible to obtain an ultrasonic panoramic image along a desired track and the like.

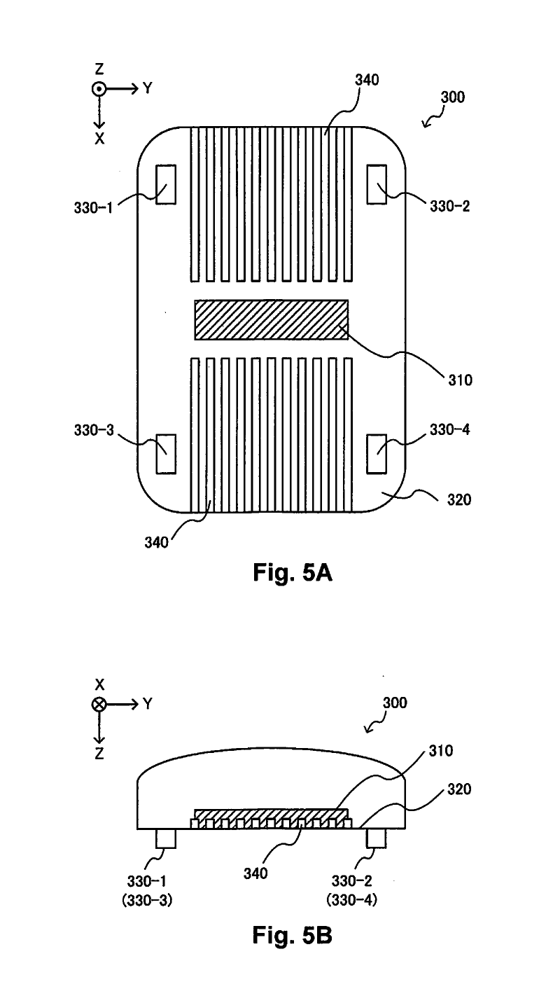

FIG. 5A and FIG. 5B illustrate a second configuration example of the ultrasonic probe 300 of the present embodiment. The ultrasonic probe 300 which is the second configuration example includes the ultrasonic sensor section 310, first to fourth engaging portions 330-1 to 330-4, and the probe side groove sections 340. Here, the ultrasonic probe 300 of the present embodiment is not limited to the configuration in FIG. 5A and FIG. 5B, and various modified examples are possible such as omitting a portion of constituent components of the ultrasonic probe 300, replacing other constituent components, adding constituent components, or the like. It is possible to, for example, omit the probe side groove sections 340.

FIG. 5A is a diagram which is viewed from the Z direction side, that is, the side of the sensor surface 320 which is the surface which faces the target sample side during measurement and FIG. 5B is a schematic diagram which is viewed from the −X direction side. Here, each of the X, Y, and Z directions correspond to the directions shown in FIG. 1.

Since the ultrasonic sensor section 310 was already described in FIG. 1, FIG. 3A, and FIG. 3B, detailed description will be omitted here.

The first to fourth engaging portions 330-1 to 330-4 are provided at first to fourth corner sections of the sensor surface 320 and guide movement of the ultrasonic probe 300 in the longitudinal direction of the sheet.

In a case where the range of the X coordinate x in the region where the ultrasonic sensor section 310 is provided in the sensor surface 320 is set to xa≦x≦xb and the range of the Y coordinate y is set to ya≦y≦yb, the first corner section is a region where x<xa and y<ya in the sensor surface 320. In addition, the second corner section is a region where x<xa and y>yb in the sensor surface 320, the third corner section is a region where x>xb and y<ya in the sensor surface 320, and the fourth corner section is a region where x>xb and y>yb in the sensor surface 320.

For example, as shown in FIG. 5A and FIG. 5B, the first to fourth engaging portions 330-1 to 330-4 are members which have a length in the X direction and a width in the Y direction and which protrude from the sensor surface 320 in the Z direction (the target sample side) and the cross section along the Y direction has a shape which is rectangular or close to rectangular. Here, the shapes of the first to fourth engaging portions 330-1 to 330-4 are not limited to the shapes shown in the diagram, and may be, for example, a columnar shape, an elliptical columnar shape, or the like. In addition, the first to fourth engaging portions 330-1 to 330-4 may have shapes which are different to each other. In addition, the first to fourth engaging portions 330-1 to 330-4 need not be arranged symmetrically with each other with regard to a central axis which passes through the center of the sensor surface 320 and which is parallel with the X direction or a central axis which passes through the center of the sensor surface 320 and which is parallel with the Y direction.

Since the probe side groove sections 340 were already described in FIG. 3A and FIG. 3B, detailed description will be omitted here.

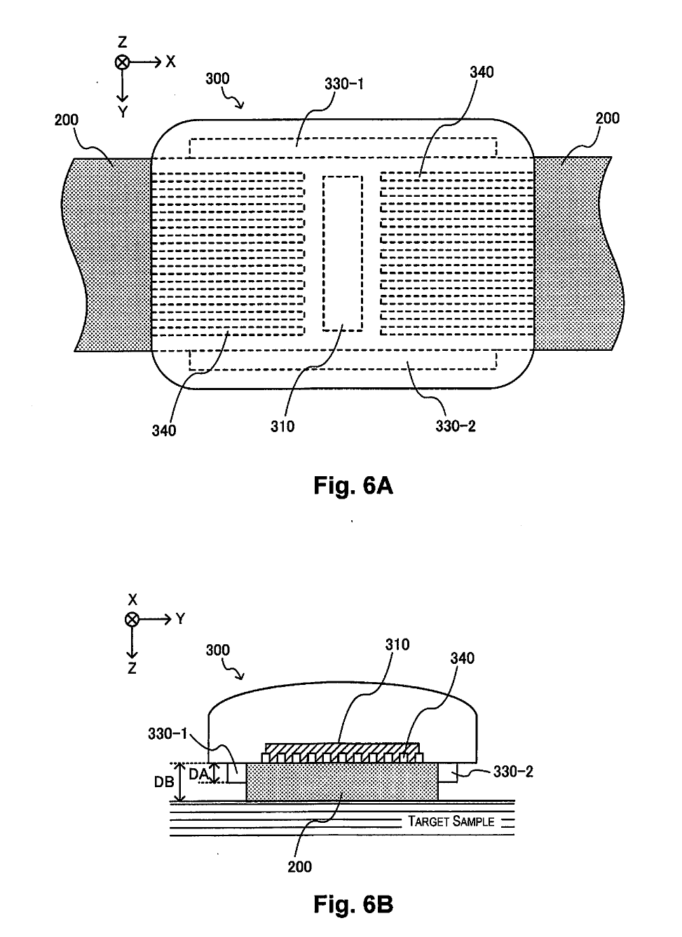

FIG. 6A and FIG. 6B illustrate a first example of ultrasonic measurement using the ultrasonic probe 300 of the present embodiment. Here, a case of using the ultrasonic probe 300 and the sheet 200 of the first configuration example will be illustrated. FIG. 6A is a diagram which is viewed from the direction side, that is, the opposite side to the sensor surface 320 and FIG. 6B is a schematic diagram which is viewed from the −X direction side.

The sheet 200 is a sheet which is arranged for use between the ultrasonic probe 300 and the target sample, is configured by an ultrasonic transmissive medium which is transmissive with regard to ultrasonic waves, and is fixed to the target sample surface during ultrasonic measurement. The ultrasonic probe 300 emits ultrasonic waves with regard to the target sample (the target object) via the sheet 200. It is possible for the sheet 200 to transmit ultrasonic waves which are emitted from the ultrasonic sensor section 310 to the target sample.

The sheet 200 is a sheet which is transmissive with regard to ultrasonic waves and which is provided between the ultrasonic probe 300 and the target sample in order to secure acoustic matching (acoustic impedance matching) between the ultrasonic sensor section 310 and the target sample during ultrasonic measurement.

The sheet 200 has sheet side engaging sections which engage with the probe side engaging sections 330. The sheet side engaging sections are portions of the sheet 200 and need not have a particular structure as long as the sheet side engaging sections are in a state where it is possible to engage with the probe side engaging sections 330. The sheet side engaging section may be an end portion in the width direction of the sheet 200, for example, as shown in FIG. 6A and FIG. 6B.

Due to the first engaging portion 330-1 engaging with the end portion on the −Y direction side of the sheet 200 and the second engaging portion 330-2 engaging with the end portion on the +Y direction side of the sheet 200, it is possible to guide movement of the ultrasonic probe 300 in the longitudinal direction (in the X direction) of the sheet 200. In detail, due to the first and second engaging portions 330-1 and 330-2 coming into contact with the end portion on the +Y direction side of the sheet 200 and the end portion on the −Y direction side of the sheet 200 as a pair of engaging sections and fitting with the sheet 200, it is possible to guide movement of the ultrasonic probe 300. That is, the surface (end surface) of the end portion on the −Y direction side of the sheet 200 and the surface of the first engaging portion 330-1 which opposes this surface come into contact, the surface of the end portion on the +Y direction side of the sheet 200 and the surface of the second engaging portion 330-2 which opposes this surface come into contact, and it is possible to restrict movement of the ultrasonic probe 300 in the Y direction which is a direction which is orthogonal to the surface.

The end portions of the sheet 200 are portions which include the surface on the +Y direction side and the vicinity of the surface on the +Y direction side and portions which include the surface on the −Y direction side and the vicinity of the surface on the −Y direction side out of the six surfaces which form the outer surfaces of the sheet 200.

Heights DA of the first and second engaging portions 330-1 and 330-2 are equal to or less than a thickness DB of the sheet 200. Here, each of the heights DA of the first and second engaging portions 330-1 and 330-2 may be different.

FIG. 6A and FIG. 6B illustrate a case of the first configuration example (FIG. 3A and FIG. 3B) of the ultrasonic probe 300 as an example, but the same also applies to a case of the modified example (FIG. 4A and FIG. 4B) of the first configuration example. In addition, the same also applies to a case of the second configuration example (FIG. 5A and FIG. 5B). That is, due to the first and third engaging portions 330-1 and 330-3 engaging with the end portions on the −Y direction side of the sheet 200 and the second and fourth engaging portions 330-2 and 330-4 engaging with the end portions on the +Y direction side of the sheet 200, it is possible to guide movement of the ultrasonic probe 300 in the longitudinal direction (in the X direction) of the sheet 200.

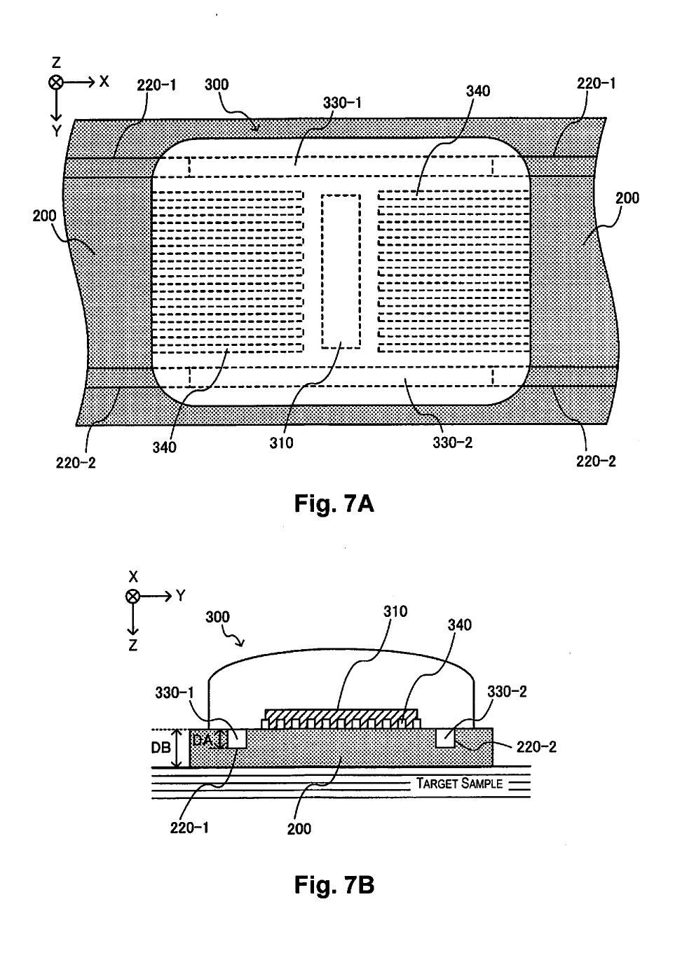

FIG. 7A and FIG. 7B illustrate a second example of ultrasonic measurement using the ultrasonic probe 300 of the present embodiment. Here, a case of using the ultrasonic probe 300 and the sheet 200 of the first configuration example will be illustrated. FIG. 7A is a diagram which is viewed from the −Z direction side, that is, the opposite side to the sensor surface 320, and FIG. 7B is a schematic diagram which is viewed from the −X direction side.

The sheet 200 shown in FIG. 7A and FIG. 7B includes first and second groove sections (the sheet side engaging sections) 220-1 and 220-2 which are provided along the longitudinal direction (the X direction) of the sheet 200. The first and second groove sections 220-1 and 220-2 are groove sections which guide movement of the ultrasonic probe 300.

The first and second groove sections 220-1 and 220-2 are groove sections which are provided on the surface on the ultrasonic probe 300 side of the sheet 200, which have a length in the X direction, a width in the Y direction, and a depth in the Z direction, and which are openings in the surface on the ultrasonic probe 300 side of the sheet 200. The first and second groove sections 220-1 and 220-2 have concave shapes in a cross section along the Y direction. The first groove section 220-1 is provided on the −Y direction side with regard to a central axis along the longitudinal direction (the X direction) of the sheet 200 and the second groove section 220-2 is provided on the +Y direction side with regard to the central axis along the longitudinal direction (the X direction) of the sheet 200.

Due to the first engaging portion 330-1 fitting with (engaging with) the first groove section 220-1 of the sheet 200 and the second engaging portion 330-2 fitting with the second groove section 220-2 of the sheet 200, it is possible to guide movement of the ultrasonic probe 300 in the longitudinal direction (in the X direction) of the sheet 200. That is, the surface of the first engaging portion 330-1 and the surface of the first groove section 220-1 which opposes this surface come into contact, the surface of the second engaging portion 330-2 and the surface of the second groove section 220-2 which opposes this surface come into contact, and it is possible to restrict movement of the ultrasonic probe 300 in the Y direction which is a direction which is orthogonal to the surface.

The heights DA of the first and second engaging portions 330-1 and 330-2 from the sensor surface 320 are equal to or less than the thickness DB of the sheet 200. Here, each of the heights DA of the first and second engaging portions 330-1 and 330-2 may be different. The heights DA of the first and second engaging portions 330-1 and 330-2 are lengths from the sensor surface 320 to the front ends which protrude in the Z direction.

FIG. 7A and FIG. 7B illustrate a case of the first configuration example (FIG. 3A and FIG. 3B) of the ultrasonic probe 300 as an example, but the same also applies to a case of the modified example (FIG. 4A and FIG. 4B) of the first configuration example. In addition, the same also applies to a case of the second configuration example (FIG. 5A and FIG. 5B). That is, due to the first and third engaging portions 330-1 and 330-3 engaging with the first groove section 220-1 of the sheet 200 and the second and fourth engaging portions 330-2 and 330-4 engaging with the second groove section 220-2 of the sheet 200, it is possible to guide movement of the ultrasonic probe 300 in the longitudinal direction (the X direction) of the sheet 200.

### 2. Sheet

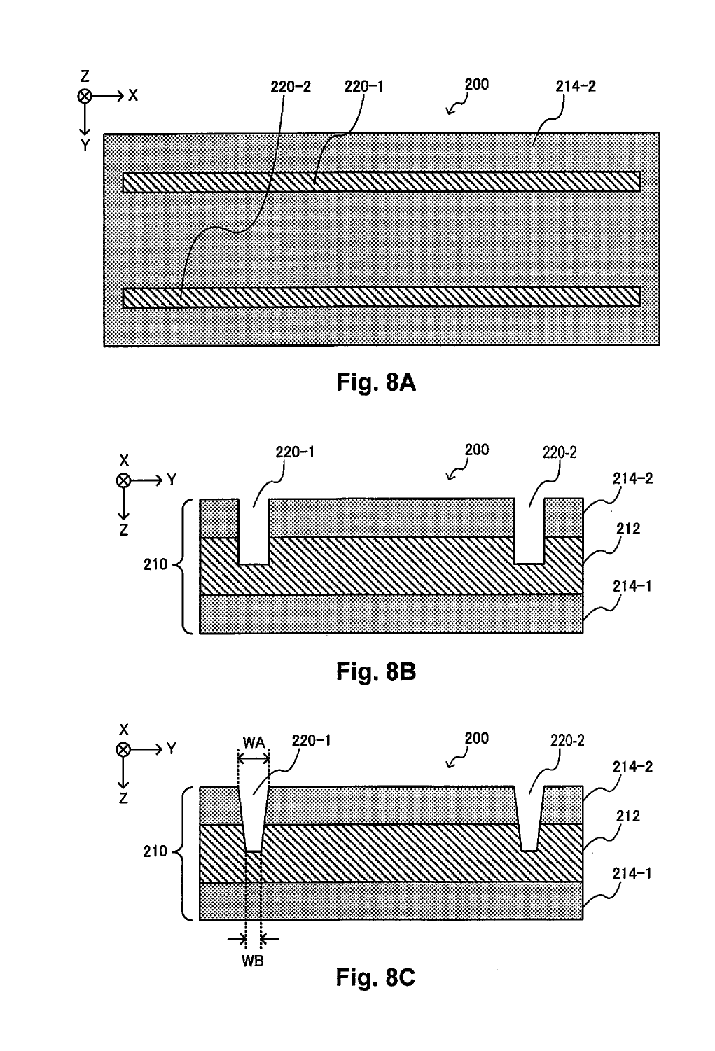

FIG. 8A and FIG. 8B illustrate a configuration example of the sheet 200 of the present embodiment. The sheet 200 includes an ultrasonic transmissive medium 210 and the groove sections (the sheet side engaging sections) 220 (220-1 and 220-2). In detail, a base sheet 212 and first and second gel layers 214-1 and 214-2 are included as the ultrasonic transmissive medium 210. In addition, the first and second groove sections 220-1 and 220-2 are included as the groove sections 220. Here, the sheet 200 is not limited to the configuration in FIG. 8A and FIG. 8B, and various modified examples are possible such as omitting a portion of constituent components of the sheet 200, replacing other constituent components, adding constituent components, or the like.

In FIG. 8A and FIG. 8B, the longitudinal direction of the sheet 200 is the X direction, the direction which intersects with the X direction is the Y direction, and the direction which intersects with the X direction and the Y direction and which is the direction (the direction which faces the target sample) in which the ultrasonic waves are emitted during ultrasonic measurement is the Z direction.

FIG. 8A is a diagram (an upper surface diagram) where the sheet 200 is viewed from the −Z direction side, that is, the side where the ultrasonic probe is set during ultrasonic measurement. In addition, FIG. 8B is a cross section diagram in the Y direction of the sheet 200.

It is desirable that the ultrasonic transmissive medium 210 be formed from a material which is transmissive with regard to ultrasonic waves, which has an acoustic impedance which is close to the human body, and which has little attenuation. The ultrasonic transmissive medium 210 is formed of, for example, oil gel, acrylamide, hydrogel, or the like. Then, the ultrasonic transmissive medium 210 is used to be brought into close contact with the target sample.

The base sheet 212 is a base material of the sheet 200, and it is desirable that it be difficult for the shape of the base sheet 212 to change even when pressure is applied during measurement. The first gel layer 214-1 is provided on the sheet surface on the opposite side to the sheet surface, where the groove sections 220-1 and 220-2 of the base sheet 212 are provided, that is, the surface on the target sample side of the base sheet 212. In addition, the second gel layer 214-2 is provided on the sheet surface, where the groove sections 220-1 and 220-2 of the base sheet 212 are provided, that is, the surface on the ultrasonic probe side of the base sheet 212. It is desirable that it be easy for the first and the second gel layers 214-1 and 214-2 to change shape so as to come into close contact with the ultrasonic probe and the target sample during measurement. Here, there may be a configuration where either or both of the first and the second gel layers 214-1 and 214-2 are not provided. Gel may be coated on, for example, the surface of the ultrasonic probe side of the base sheet 212 during ultrasonic measurement without the second gel layer 214-2 being provided.

The first and second groove sections 220-1 and 220-2 are groove sections which are provided on the surface on the ultrasonic probe side (the −Z direction side) of the sheet 200, which have a length in the X direction, a width in the Y direction, and a depth in the Z direction, and which are openings in the surface on the ultrasonic probe side of the sheet 200. The first and second groove sections 220-1 and 220-2 have concave shapes in a cross section along the Y direction. The first groove section 220-1 is provided on the −Y direction side with regard to the central axis along the longitudinal direction (the X direction) of the sheet 200 and the second groove section 220-2 is provided on the +Y direction side with regard to the central axis along the longitudinal direction (the X direction) of the sheet 200.

The first and second groove sections 220-1 and 220-2 are formed at least in the base sheet 212. Since it is difficult for the shape of the base sheet 212 to change even when pressure is applied during measurement, it is possible to prevent the groove sections 220-1 and 220-2 from changing shape. As shown in FIG. 8B, for example, in a case where the second gel layer 214-2 is provided, the groove sections 220 are formed in the base sheet 212 and the second gel layer 214-2.

FIG. 8C illustrates a modified example of the sheet 200. In the modified example, the width of the opening of the groove sections 220 is larger than the width of the bottom surface of the groove sections 220. As shown in FIG. 8C, for example, a width WA of the opening of the first groove section 220-1 is larger than a width WB of the bottom surface of the first groove section 220-1. The same applies to the second groove section 220-2. The width WA of the opening is the length in the Y direction of the opening sections which are openings in the surfaces on the ultrasonic probe side of the first and second groove sections 220-1 and 220-2. The width WB of the bottom surface is the length in the Y direction of the bottom surface which opposes the opening section of the first and second groove sections 220-1 and 220-2.

By doing this, since it is possible for the groove sections to engage with the probe side engaging sections which are various shapes in the ultrasonic probe, it is possible to increase the versatility of the sheet 200 or the like. In addition, it is possible for the groove sections to correspond to the probe side engaging sections which are worn.

Here, the shapes of the first and second groove sections 220-1 and 220-2 are not limited to the shapes shown in FIG. 8A, FIG. 8B, and FIG. 8C. In addition, the first and second groove sections 220-1 and 220-2 may have shapes which are different to each other.

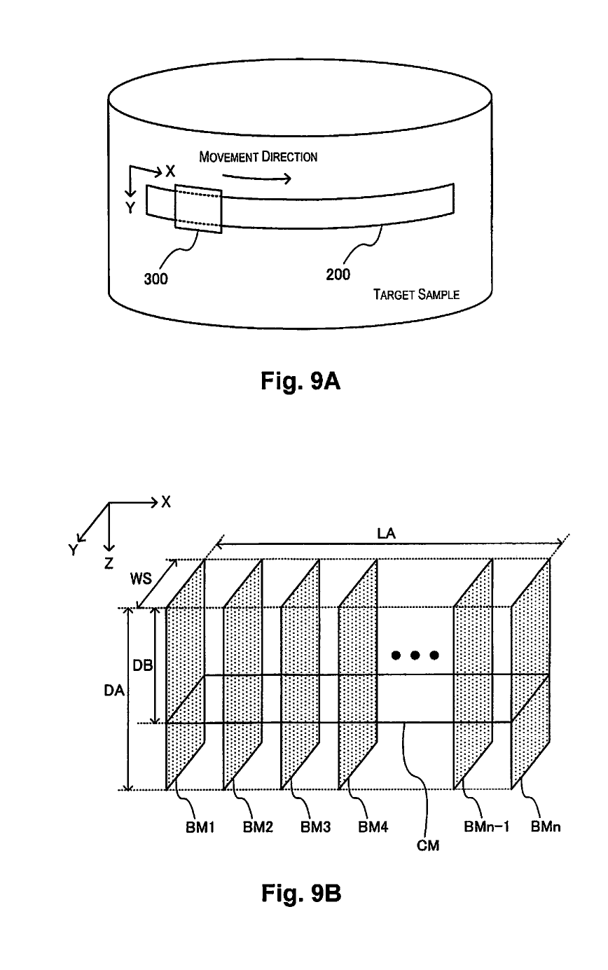

FIG. 9A is a diagram which describes movement of the ultrasonic probe 300 which is guided by the sheet 200. The longitudinal direction of the sheet 200 is the X direction.

As described above, due to the end portions or the groove sections 220 of the sheet 200 which is fixed to the target sample engaging with the probe side engaging sections 330 of the ultrasonic probe 300, it is possible to guide movement of the ultrasonic probe 300 in the longitudinal direction (in the X direction) of the sheet 200.

As shown in FIG. 9A, the user fixes the sheet 200 in a measurement target part (the region of interest) of the target sample and sets the ultrasonic probe 300 above this. At this time, the scanning direction or the slice direction is set to be parallel with the X direction. Movement of the ultrasonic probe 300 in the Y direction is restricted, but movement in the X direction is not restricted. That is, it is possible for the ultrasonic probe 300 to move freely in the longitudinal direction of the sheet 200. As a result, it is possible to reliably move the ultrasonic probe 300 in the scanning direction or the slice direction along the track which is defined by the sheet 200. In addition, since it is possible to fix the sheet 200 to match the shape or the like of the target sample, it is possible to accurately move the ultrasonic probe 300 to match with the various shapes, body types, and the like of parts to be measured.

Since it is possible to perform ultrasonic measurement while moving the ultrasonic probe 300 in this manner along a predetermined track, it is possible for it to be easy to, for example, acquire a plurality of ultrasonic images along the predetermined track for the measurement target part. Then, it is possible to obtain an ultrasonic panoramic image or a three-dimensional ultrasonic image based on the plurality of ultrasonic images along the predetermined track.

FIG. 9B is a diagram which describes generating of a three-dimensional ultrasonic image using an ultrasonic measuring system 400 of the present embodiment. The three-dimensional ultrasonic image is an ultrasonic image in three dimensions which is obtained by acquiring a plurality of ultrasonic image data (B mode image data) while moving the ultrasonic probe in the slice direction along the predetermined track and joining (synthesizing) the plurality of ultrasonic image data which was acquired.

It is possible for the user to perform measurement while moving the ultrasonic probe 300 in the longitudinal direction (the X direction) of the sheet 200, that is, along the track which is defined according to the sheet 200. By doing this, it is possible for the ultrasonic measuring system 400 to acquire B mode image data BM1 to BMn (where n is an integer of 2 or more) for a region which, for example, has a width WS (scanning width) in the scanning direction (the Y direction), has a length LA in the slice direction (the X direction), and has a depth DA in the depth direction (the Z direction) as shown in FIG. 9B.

It is possible for a processing section 130 (FIG. 12) of the ultrasonic measuring system 400 to generate three-dimensional ultrasonic images in the region with the width WS, the length LA, and the depth DA based on the B mode image data BM1 to BMn which are acquired. The length LA, that is, the movement distance of the ultrasonic probe is defined by the length of the sheet 200 in the longitudinal direction.

According to the ultrasonic probe 300 and the sheet 200 of the present embodiment as described above, since it is possible to accurately move the ultrasonic probe along the track which is defined by the sheet, it is possible to accurately move the ultrasonic probe along the predetermined track even in a case where the movement distance of the ultrasonic probe is long. As a result, it is possible to acquire an accurate panoramic image or a three-dimensional ultrasonic image across a wider range.

In addition, according to the ultrasonic measuring system 400 of the present embodiment, it is possible to also generate a C mode image CM based on the B mode image data BM1 to BMn. Here, the C mode image CM is, for example, an ultrasonic image which relates to a cross section with the width WS, the length LA, and the depth DB as shown in FIG. 9B.

As described above, according to the ultrasonic probe 300 and the sheet 200 of the present embodiment, it is possible to guide movement of the ultrasonic probe in the longitudinal direction of the sheet by the probe side engaging sections of the ultrasonic probe engaging with the end portions or the groove sections of the sheet. As a result, it is possible for the user to easily acquire a plurality of ultrasonic images or the like while accurately moving the ultrasonic probe along the track which is defined by the sheet using a simple configuration. Furthermore, based on the plurality of ultrasonic images which are acquired in this manner, it is possible to obtain an ultrasonic panoramic image, a three-dimensional ultrasonic image, or the like.

### 3. Ultrasonic Transducer Device

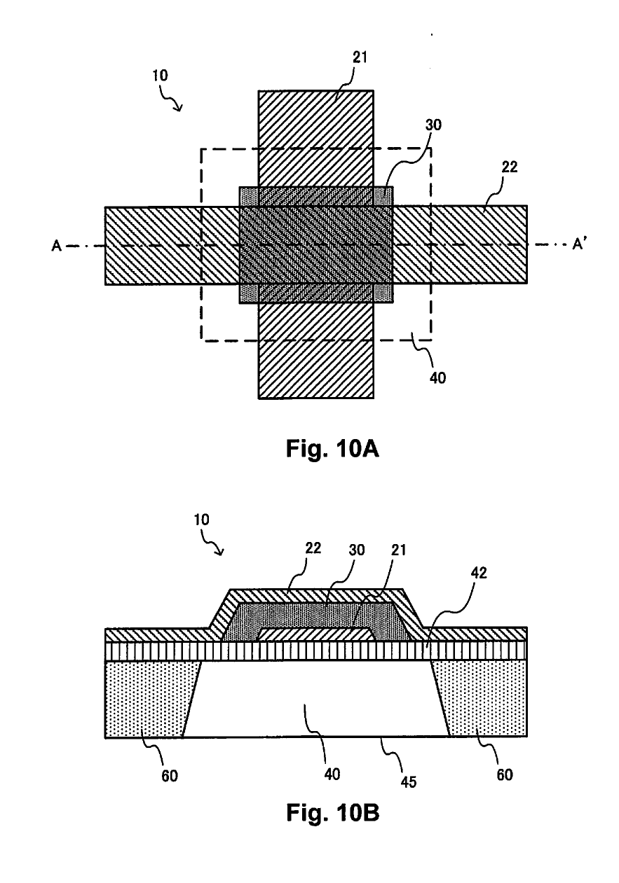

The ultrasonic sensor section 310 of the ultrasonic probe 300 of the present embodiment has an ultrasonic transducer device 312. FIG. 10A and FIG. 10B illustrate a basic configuration example of an ultrasonic transducer element 10 (a thin film piezoelectric ultrasonic transducer element) of the ultrasonic transducer device 312. The ultrasonic transducer element 10 has a vibrating film 42 and a piezoelectric element section. The piezoelectric element section has a first electrode layer 21, a piezoelectric film 30, and a second electrode layer 22. Here, the ultrasonic transducer element 10 of the present embodiment is not limited to the configuration in FIG. 10A and FIG. 10B and various modified examples are possible such as omitting a portion of constituent components of the ultrasonic transducer element 10, replacing other constituent components, adding constituent components, or the like.

FIG. 10A is a plan view of the ultrasonic transducer element 10 which is formed on a substrate 60 (a silicon substrate) viewed from a direction which is orthogonal to the substrate on the element forming surface side. FIG. 10B is a cross sectional diagram illustrating a cross section along A-A′ in FIG. 10A.

The first electrode layer 21 (a lower section electrode) is formed on an upper layer of the vibrating film 42 using, for example, a metal thin film. The first electrode layer 21 may be wiring which extends to the outside of the element forming region and is connected with the ultrasonic transducer element 10 which is adjacent as shown in FIG. 10A.

The piezoelectric film 30 (the piezoelectric body layer) is formed using, for example, a PZT (lead zirconate titanate) thin film and is provided so as to cover at least a portion of the first electrode layer 21. Here, the material of the piezoelectric film 30 is not limited to PZT, and, for example, lead titanate (PbTiO₃), lead zirconate (PbZrO₃), lead lanthanum titanate ((Pb, La) TiO₃), or the like may be used.

The second electrode layer 22 (an upper section electrode) is formed, for example, using a metal thin film and is provided so as to cover at least a portion of the piezoelectric film 30. The second electrode layer 22 may be wiring which extends to the outside of the element forming region and is connected with the ultrasonic transducer element 10 which is adjacent as shown in FIG. 10A.

The vibrating film 42 (a membrane) is provided so as to block an opening 45 using, for example, a two layer structure of a SiO₂ thin film and a ZrO₂ thin film. It is possible for the vibrating film 42 to support the piezoelectric film 30 and the first and second electrode layers 21 and 22, to vibrate according to expansion and contraction of the piezoelectric film 30, and to generate ultrasonic waves.

The opening 45 is arranged on the substrate 60. A cavity region 40 due to the opening 45 is formed by etching from the rear surface (surface where the element is not formed) side of the substrate 60 using reactive ion etching (RIE) or the like. The resonant frequency of the ultrasonic waves is determined by the size of the vibrating film 42 which is able to vibrate due to forming of the cavity region 40, and the ultrasonic waves are radiated to the piezoelectric film 30 side (in a forward direction from the far side of the paper surface in FIG. 10A).

A lower section electrode of the ultrasonic transducer element 10 is formed by the first electrode layer 21 and an upper section electrode is formed by the second electrode layer 22. In detail, a portion, which is covered by the piezoelectric film 30, out of the first electrode layer 21 forms the lower section electrode and a portion, which covers the piezoelectric film 30, out of the second electrode layer 22 forms the upper section electrode. That is, the piezoelectric film 30 is provided to be interposed by the lower section electrode and the upper section electrode.

The piezoelectric film 30 extends and contracts in an in-plane direction by a voltage being applied between the lower section electrode and the upper section electrode, that is, between the first electrode layer 21 and the second electrode layer 22. The ultrasonic transducer element 10 uses a monomorph (unimorph) structure where a thin piezoelectric element section and the vibrating film 42 are bonded, and warping is generated since the dimensions of the bonded vibrating film 42 remain unchanged when the piezoelectric element section expands and contracts in the plane. Accordingly, by applying an alternating current voltage to the piezoelectric film 30, the vibrating film 42 vibrates with regard to the film thickness direction and ultrasonic waves are radiated due to vibration of the vibrating film 42. The voltage which is applied to the piezoelectric film 30 is, for example, 10 V to 30 V, and the frequency is, for example, 1 MHz to 10 MHz.

While the driving voltage of a bulk ultrasonic transducer element is approximately 100 V from peak to peak, it is possible to reduce the driving voltage of the thin film piezoelectric ultrasonic transducer element as shown in FIG. 10A and FIG. 10B to approximately 10 V to 30 V from peak to peak.

The ultrasonic transducer element 10 also operates as a receiving element which receives ultrasonic echoes which are returned by the ultrasonic waves which are emitted being reflected by the target object. The vibrating film 42 vibrates due to the ultrasonic echoes, pressure is applied to the piezoelectric film 30 due to the vibrations, and a voltage is generated between the lower section electrode and the upper section electrode. It is possible to extract the voltage as a reception signal.

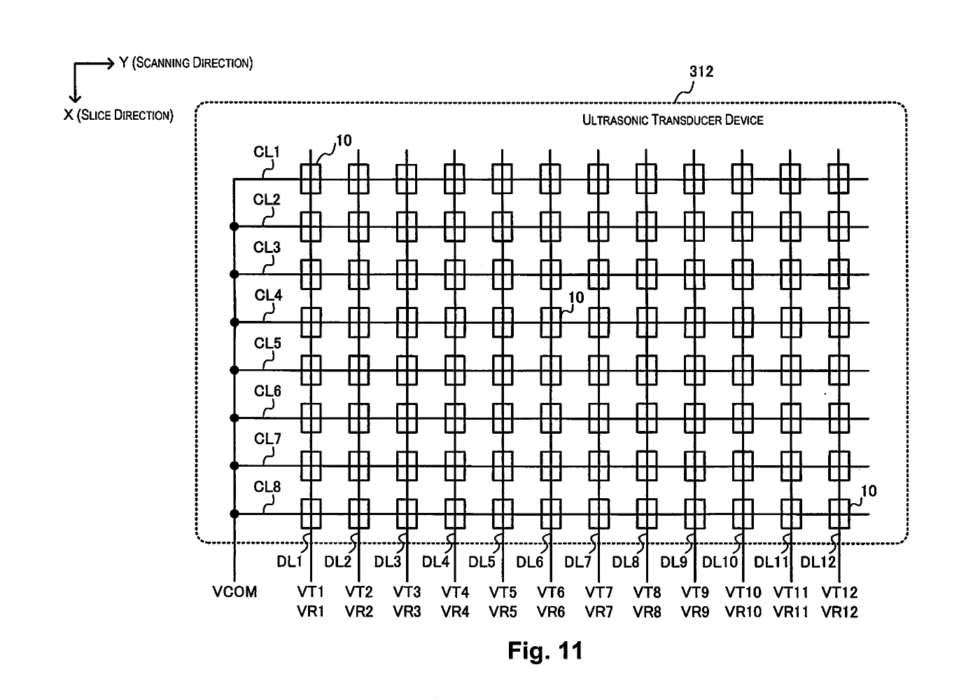

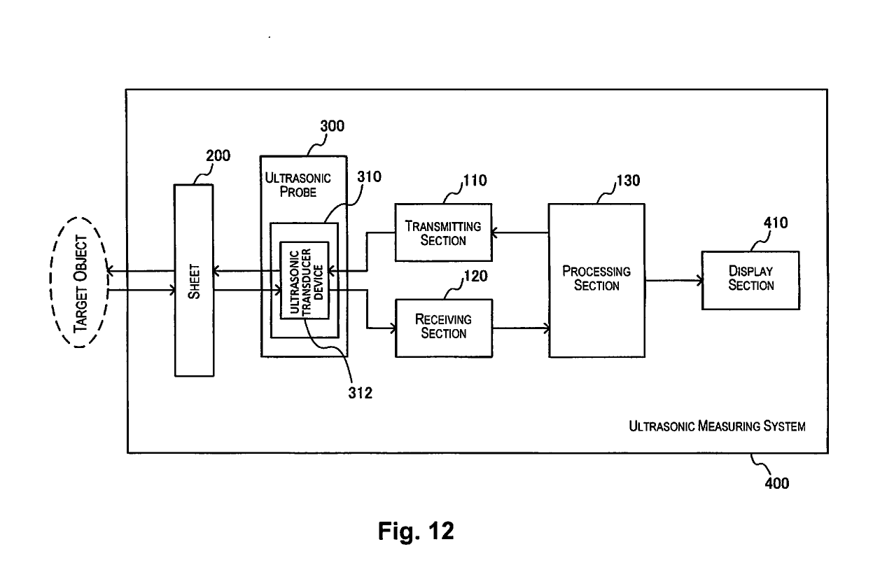

FIG. 11 illustrates a configuration example of the ultrasonic transducer device 312 of the ultrasonic probe 300 of the present embodiment. The ultrasonic transducer device 312 of the present configuration example includes a plurality of the ultrasonic transducer elements 10 which are arranged in an array formation, 1^{st} to n^{th} (where n is an integer of 2 or more) driving electrode lines DL1 to DLn, and 1^{st} to m^{th} (where m is an integer of 2 or more) common electrode lines CL1 to CLm. FIG. 11 illustrates a case where m=8 and n=12 as an example, but m and n may be values which are different to these. Here, the ultrasonic transducer device 312 of the present embodiment is not limited to the configuration shown in FIG. 11, and various modified examples are possible such as omitting a portion of constituent components of the ultrasonic transducer device 312, replacing other constituent components, adding constituent components, or the like.

The plurality of ultrasonic transducer elements 10 are arranged in a matrix formation with m rows and n columns. For example, 8 rows are arranged in the X direction and 12 columns are arranged in the Y direction which intersects with the X direction as shown in FIG. 11. It is possible for the ultrasonic transducer element 10 to have, for example, the configuration shown in FIG. 10A and FIG. 10B.

1^{st} to 12^{th} (n^{th})) driving electrode lines DL1 to DL12 are arranged in the X direction. The j^{th} (j is an integer where 1≦j≦12) driving electrode line DLj out of the 1^{st} to 12^{th} driving electrode lines DL1 to DL12 is connected with a first electrode of each of the ultrasonic transducer elements 10 which are arranged in the j^{th} column.

In the transmission period when ultrasonic waves are emitted, 1^{st} to 12^{th} transmission signals VT1 to V12 which are output by a transmitting section 110 which will be described later are supplied to each of the ultrasonic transducer elements 10 via the driving electrode lines DL1 to DL12. In addition, in the receiving period when ultrasonic echo signals are received, reception signals VR1 to VR12 from the ultrasonic transducer elements 10 are output to a receiving section 120 which will be described later via the driving electrode lines DL1 to DL12.

1^{st} to 8^{th} (mth)) common electrode lines CL1 to CL8 are arranged in the Y direction. A second electrode of the ultrasonic transducer element 10 is connected with any out of the 1^{st} to m^{th} common electrode lines CL1 to CLm. In detail, an i^{th} (i is an integer where common electrode line CLi out of the 1^{st} to 8^{th} common electrode lines CL1 to CL8 is connected with, for example, the second electrodes of each of the ultrasonic transducer elements 10 which are arranged in the i^{th} column as shown in FIG. 11.

A common voltage VCOM is supplied to the 1^{st} to 8^{th} common electrode lines CL1 to CL8. As long as the common voltage is a fixed direct current voltage, the common voltage need not be 0 V, that is, the ground potential.

For the ultrasonic transducer element 10 of the 1^{st} row and the 1^{st} column, for example, the first electrode is connected with the 1^{st} driving electrode line DL1 and the second electrode is connected with the 1^{st} common electrode line CL1. In addition, for example, for the ultrasonic transducer element 10 of the 4^{th} row and the 6^{th} column, the first electrode is connected with the 6^{th} driving electrode line DL6 and the second electrode is connected with the 4^{th} common electrode line CL4.

Here, the arrangement of the ultrasonic transducer elements 10 is not limited to the matrix arrangement with m rows and n columns shown in FIG. 11. The arrangement may be, for example, a so-called zigzag arrangement where m ultrasonic transducer elements 10 are arranged in odd numbered rows and m−1 ultrasonic transducer elements 10 are arranged in even numbered columns.

The elements which are included in the ultrasonic transducer device 312 are not limited to the thin film piezoelectric ultrasonic transducer elements described above, and may be, for example, bulk piezoelectric ultrasonic transducer elements or may be capacitive micromachined ultrasound transducer elements (CMUT).

### 4. Ultrasonic Measuring System

FIG. 12 illustrates a basic configuration example of the ultrasonic measuring system 400 of the present embodiment. The ultrasonic measuring system 400 includes the sheet 200, the ultrasonic probe 300, the transmitting section 110, the receiving section 120, the processing section 130, and a display section 410.

Since the sheet 200 and the ultrasonic probe 300 were already described above, detailed description will be omitted here.

The transmitting section 110 performs a process of transmitting ultrasonic waves. In detail, ultrasonic waves are emitted with regard to the target object by the transmitting section 110 outputting a transmission signal (the driving signal) with regard to the ultrasonic probe 300 and the ultrasonic transducer device 312 of the ultrasonic probe 300 converting the transmission signal, which is an electric signal, into ultrasonic waves. At least a portion of the transmitting section 110 may be provided in the ultrasonic probe 300.

The receiving section 120 performs a process of receiving ultrasonic echoes. In detail, the ultrasonic transducer device 312 of the ultrasonic probe 300 converts ultrasonic echoes from the target object into an electric signal. Then, the receiving section 120 performs a receiving process such as amplification, detection, A/D conversion, and phase adjustment with regard to the reception signal (an analog signal) which is an electric signal from the ultrasonic transducer device 312, and outputs the reception signal (digital data), which is the signal after the receiving process, with regard to the processing section 130. At least a portion of the receiving section 120 may be provided in the ultrasonic probe 300.

The processing section 130 performs a process of controlling ultrasonic measurement and an image data generating process or the like based on the reception signal from the receiving section 120. For example, it is possible for the processing section 130 to acquire a plurality of units of ultrasonic image data along the longitudinal direction of the sheet 200 and to generate an ultrasonic panoramic image in the longitudinal direction of the sheet 200 based on the plurality of ultrasonic images which are acquired. The image data which is generated is output to the display section 410.

The display section 410 is, for example, a display apparatus such as a liquid crystal display or an organic EL display and displays image data for display from the processing section 130.

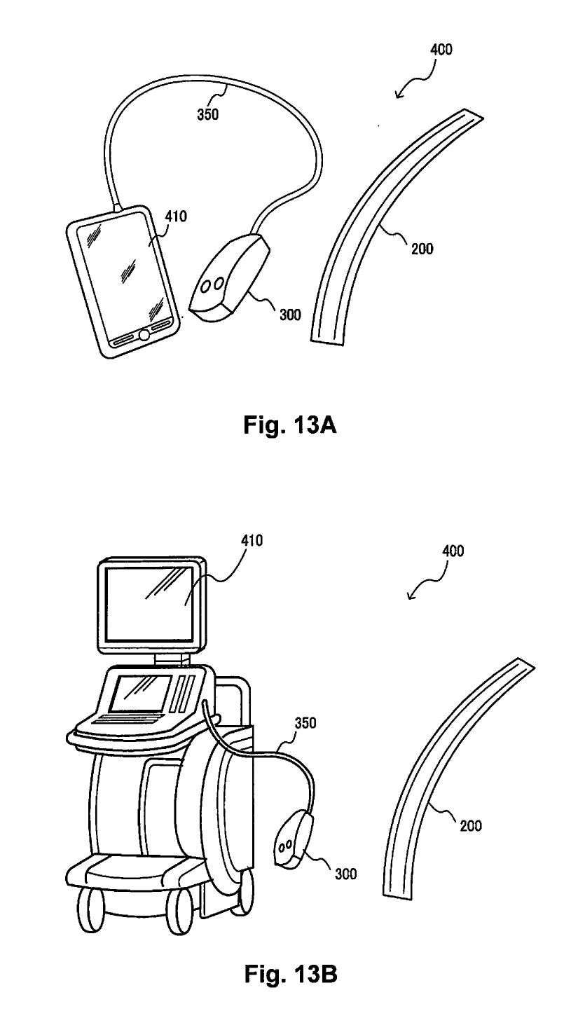

FIG. 13A and FIG. 13B illustrate basic configuration examples of the ultrasonic measuring system 400. FIG. 13A illustrates the ultrasonic measuring system 400, which is a portable type, and FIG. 13B illustrates the ultrasonic measuring system 400, which is a stationary type.

During measurement, the sheet 200 is fixed to the measurement target part (the region of interest) of the target sample and the ultrasonic probe 300 is set above this. The ultrasonic probe 300 is connected with the ultrasonic measuring system body by a cable 350. The display section 410 displays image data for display.

As described above, according to the ultrasonic measuring system 400 of the present embodiment, it is possible to easily perform acquiring of a plurality of ultrasonic images or the like while accurately moving the ultrasonic probe along the desired track using a simple configuration. Furthermore, based on the plurality of ultrasonic images which are acquired in this manner, it is possible to obtain an ultrasonic panoramic image, a three-dimensional ultrasonic image, or the like.

Here, the present embodiment was described in detail above, but it can be easily understood by a person skilled in the art that many modifications are possible in a range which substantially does not depart from the novel matters and effects of the present invention. Accordingly, the modified examples are all included in the range of the present invention. For example, in the specifications and diagrams, it is possible for terms, which are described along with different terms which have a broader or similar meaning, to be replaced at least once with the different terms in any locations in any of the specifications or diagrams. In addition, the configuration and operations of the ultrasonic measuring system, the ultrasonic probe, and the sheet are not limited to the configuration and operations which are described in the present embodiment and various modified examples are possible.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An ultrasonic measuring system comprising:
an ultrasonic probe having an ultrasonic sensor section and a probe side engaging section; and
a sheet member through which ultrasonic waves emitted from the ultrasonic sensor section are transmitted to a target sample, the sheet member having a sheet side engaging section,
the probe side engaging section slidably engaging with the sheet side engaging section so that the ultrasonic probe slides along the sheet member while the ultrasonic sensor section faces a sheet surface of the sheet member.

2. The ultrasonic measuring system according to claim 1, wherein
the sheet side engaging section is defined by a pair of end portions of the sheet member in a width direction of the sheet member.

3. The ultrasonic measuring system according to claim 1, wherein
the sheet side engaging section is defined by a groove section arranged on the sheet surface.

4. The ultrasonic measuring system according to claim 3, wherein
the probe side engaging section includes a first engaging portion and a second engaging portion,
the groove section includes a first groove portion and a second groove portion,
the first engaging portion engages with the first groove portion, and
the second engaging portion engages with the second groove portion.

5. The ultrasonic measuring system according to claim 4, wherein
the ultrasonic sensor section is disposed between the first engaging portion and the second engaging portion.

6. The ultrasonic measuring system according to claim 1, wherein
the ultrasonic probe includes a sensor surface on which the ultrasonic sensor section is arranged, the sensor surface having a rectangular shape in a plan view, and
the probe side engaging section includes a first engaging portion, a second engaging portion, a third engaging portion, and a fourth engaging portion disposed at four corner sections of the sensor surface in the plan view.

7. The ultrasonic measuring system according to claim 1, wherein
the probe side engaging section includes a guide section configured and arranged to guide movement of the ultrasonic probe in a longitudinal direction of the sheet member.

8. The ultrasonic measuring system according to claim 1, wherein
the ultrasonic probe has a sensor surface on which the ultrasonic sensor section is arranged with a probe side groove section being provided on the sensor surface, and
the probe side groove section extends along a longitudinal direction of the sheet member when the sheet side engaging section and the probe side engaging section are engaged.

9. The ultrasonic measuring system according to claim 1, wherein
the ultrasonic probe has a sensor surface on which the ultrasonic sensor section is arranged, and
a height of the probe side engaging section from the sensor surface is equal to or less than a thickness of the sheet member.

10. The ultrasonic measuring system according to claim 1, further comprising:
a transmitting section configured to perform a process of transmitting ultrasonic waves;
a receiving section configured to perform a process of receiving ultrasonic echoes; and
a processing section configured to perform a process of controlling ultrasonic measurement,
wherein the processing section is configured to generate an ultrasonic panoramic image in a longitudinal direction of the sheet member based on a reception signal from the receiving section.

11. The ultrasonic measuring system according to claim 1, further comprising
a display section configured to display image data.

12. An ultrasonic probe adapted to slidably engage with a sheet member arranged between the ultrasonic probe and a target sample, the ultrasonic probe comprising:
an ultrasonic sensor section disposed on a sensor surface of the ultrasonic probe; and
an engaging section disposed on the sensor surface, and configured and arranged to engage with the sheet member to guide the ultrasonic probe to slide along the sheet member while the ultrasonic sensor section faces a sheet surface of the sheet member.

13. A sheet member adapted to be arranged between an ultrasonic probe and a target sample, the sheet member comprising:
an ultrasonic transmissive medium; and
an engaging section configured and arranged to engage with the ultrasonic probe to guide the ultrasonic probe to slide along a sheet surface of the sheet member.

14. The sheet member according to claim 13, wherein
the engaging section is configured and arranged to guide the ultrasonic probe to slide in a longitudinal direction of the sheet member.

15. The sheet member according to claim 13, wherein
the engaging section includes a groove section arranged on the sheet surface.

16. The sheet member according to claim 15, wherein
the ultrasonic transmissive medium includes a base sheet made of a base material and a first gel layer disposed on a surface of the base sheet opposite from the sheet surface on which the groove section is arranged.

17. The sheet according to claim 16, wherein
the ultrasonic transmissive medium further includes a second gel layer disposed on a surface of the base sheet on a same side as the sheet surface on which the groove section is arranged.
